(19) United States
(12) Patent Application Publication
(10) Pub. No.: US 2024/0051069 A1
(43) Pub. Date: Feb. 15, 2024

(54) Method for replacing the drilling segments of a drill bit, and cutting section for a drill bit

(71) Applicant: Hilti Aktiengesellschaft, Schaan (LI)

(72) Inventors: József SZABÓ, Kecskemét (HU); Matthaeus HOOP, Eschen (LI); Quentin FURNEMONT, Buchs (CH)

(21) Appl. No.: 18/267,306

(22) PCT Filed: Dec. 6, 2021
(86) PCT No.: PCT/EP2021/084385

§ 371 Date: Jun. 14, 2023

(30) Foreign Application Priority Data
Dec. 15, 2020 (EP) 20214068.7

(51) Int. Cl. B23K 31/02; B23P 6/00

(52) U.S. Cl. CPC B23K 31/025; B23P 6/00; B23K 2101/20

(57) ABSTRACT

A method for replacing drilling segments of a drill bit, the drilling shaft (61) of which is connected to the drilling segments, with new drilling segments (32), having the steps of: severing the drilling shaft (61), plugging a cutting section (31) that comprises the new drilling segments (32) onto the severed drilling shaft (61), and connecting the cutting section (31) to the severed drilling shaft (61), wherein the cutting section (31) is connected to the severed drilling shaft (61) via at least three longitudinal weld seams (64) that are spaced apart from one another.

### FIELD OF THE INVENTION

The present invention relates to a method for replacing the drilling segments of a drill bit and to a cutting section for a drill bit.

### BACKGROUND

EP 0 428 476 B1 discloses a drill bit in which the drilling segments can be replaced. The drill bit is made up of a cutting section and a drilling shaft, which are connected together by being soldered. The known drill bit has the drawback that a specific drilling shaft is required, and the method known from EP 0 428 476 1 for replacing the drilling segments is unsuitable for drill bits with a conventional drilling shaft.

DE 103 50 025 B4 discloses a further known drill bit in which the drilling segments can be replaced. The drill bit is made up of a cutting section and a drilling shaft, which are separated by an encircling groove. In order to replace the drilling segments, the drilling shaft is severed by means of a saw or a cut-off grinder at the intended separation point. At the lower end of the drilling shaft, the encircling groove forms an inner plugging element which cooperates with a corresponding outer plugging element of a new cutting section and forms an overlapping region; the new cutting section and the severed drilling shaft are soldered together in the overlapping region. The known drill bit has the drawback that a specific drilling shaft is required. The method known from DE 103 50 025 B4 for replacing the drilling segments is unsuitable for drill bits with a conventional drilling shaft.

U.S. Pat. No. 9,097,067 B2 discloses a further known drill bit in which the drilling segments can be replaced. The drill bit is made up of a cutting section and a drilling shaft, which are connected together by being soldered. In order to replace the drilling segments, the soldered connection is heated and the old cutting section taken off. The new cutting section comprises an annular section, formed in an open manner, with a plurality of drilling segments that are connected to the annular section, and a plugging section and a stop shoulder at the transition from the annular section to the plugging element. The new cutting section is plugged onto the drilling shaft until the end face of the drilling shaft butts against the stop shoulder. The annular section is heated in the region of the expansion gap and the ring ends are fixed by soldering. Provided in the annular section are a plurality of soldering openings, via which the solder is fed; the solder is distributed uniformly on both sides of the soldering opening by capillary action. Before the solder is introduced into a soldering opening, the drilling shaft is heated on both sides of the soldering opening. The known drill bit has the drawback that a specific drilling shaft is required, and the method known from U.S. Pat. No. 9,097,067 B2 for replacing the drilling segments with a new cutting section is unsuitable for drill bits with a conventional drilling shaft.

US 2005/0279533 A1 discloses a further known drill bit in which the drilling segments can be replaced. In order to replace the old drilling segments with new drilling segments, the drilling shaft is severed by means of a saw or a cut-off grinder. Subsequently, a new cutting section is plugged onto the severed drilling shaft and the new cutting section is welded to the severed drilling shaft. In that case, the weld seam that connects the new cutting section to the severed drilling shaft extends in a plane perpendicular to the longitudinal axis of the cutting section. The cutting section comprises an annular section, a plurality of drilling segments in the form of annular sections, which are connected to the annular section, and a plugging section, which is formed in a double-walled manner with an annular gap and is connected to the annular section. In an alternative embodiment, the plugging section is formed in a conical manner, wherein the severed drilling shaft is plugged into the conical plugging section.

### SUMMARY OF THE INVENTION

The method known from US 2005/0279533 A1 for replacing the drilling segments with a new cutting section has the drawback that the weld seam that connects the cutting section and the severed drilling shaft cannot be monitored or at least can only be monitored poorly. If the drilling shaft has not just been severed, there is the risk of the cutting section and the drilling shaft not being welded together around the entire circumference.

An object of the present invention is to develop a method for replacing the drilling segments of a drill bit, the drilling shaft of which is connected to the drilling segments. In this case, the drilling segments should be able to be replaced easily and the drill bit with the new drilling segments should withstand the same loads as the original drill bit.

The method for replacing the drilling segments of a drill bit is characterized according to the invention in that the new cutting section is connected to the severed drilling shaft via at least three longitudinal weld seams that are separate from one another. The connection of the new cutting section to the severed drilling shaft via longitudinal weld seams that extend parallel to the longitudinal axis of the drilling shaft has the advantage of ensuring a sufficiently large connecting area between the severed drilling shaft and the new cutting section.

The invention also relates to a cutting section. The cutting section for a drill bit is characterized in that the annular shoulder is arranged on the inner side of the new cutting section and the cutting section has at least three plugging elements and at least three longitudinal slots, wherein the longitudinal slots separate the plugging elements from one another. The separation of the plugging elements by the longitudinal slots has the advantage that the connection between the severed drilling shaft and the new cutting section can be monitored by the operator during welding. The possibility of monitoring the overlapping height ensures that the new drill bit has the requisite properties in the connecting region.

Preferably, the at least three longitudinal slots have, in a longitudinal direction that extends parallel to the longitudinal axis, a slot height which is identical to the ring height of the plugging section. If the longitudinal slots extend over the entire second ring height of the plugging section, the severed drilling shaft can be monitored while it is being welded to the cutting section. Monitoring is important especially when the drilling shaft has been severed obliquely and the severed drilling shaft does not bear against the annular shoulder of the cutting section around its entire circumference.

In a first variant, the longitudinal slots extend to the longitudinal axis of the cutting section. In a second variant, one or more of the at least three longitudinal slots are inclined with respect to the longitudinal axis of the cutting section.

In a preferred development, the plugging section has, in the region of the at least three longitudinal slots, a marking element which extends in a plane perpendicular to the longitudinal axis of the cutting section. By means of the marking element, the operator can check whether the required overlapping height between the new cutting section and the severed drilling shaft is achieved.

When the drilling shaft is severed from the cutting section by means of a saw or cut-off grinder at the construction site, the separating cut frequently does not take place at right angles to the longitudinal axis of the drilling shaft and an obliquely extending end face is formed on the severed drilling shaft. If the end face of the severed drilling shaft extends beneath the marking element, the required overlapping height is achieved and the longitudinal weld seams have the required connecting area. If the end face of the severed drilling shaft does not have the required overlapping height at one or more longitudinal slots, the operator can rework the severed drilling shaft at the end face by means of the saw or the cut-off grinder until the end face of the severed drilling shaft has the required overlapping height at all the longitudinal slots.

Exemplary embodiments of the invention are described hereinafter with reference to the drawing. This is not necessarily intended to show the exemplary embodiments to scale; rather the drawing, where useful for explanation, is produced in a schematic and/or slightly distorted form. It should be taken into account here that various modifications and alterations relating to the form and detail of an embodiment may be undertaken without departing from the general concept of the invention. The general concept of the invention is not limited to the exact form or the detail of the preferred embodiment shown and described hereinafter or limited to subject matter that would be restricted compared to the subject matter claimed in the claims. For given dimensioning ranges, values within the stated limits should also be disclosed as limit values and should be able to be used and claimed as desired. For the sake of simplicity, the same reference signs are used hereinafter for identical or similar parts or parts having an identical or similar function.

### BRIEF DESCRIPTION OF THE FIGURES

FIGS. 1A, B show a drill bit in a first variant with an annular drilling segment (FIG. 1A) and in a second variant with a plurality of drilling segments in the form of annular sections (FIG. 11B);

FIGS. 2A, B show a cutting section with a new annular drilling segment for the drill bit from FIG. 1A (FIG. 2A) and a cutting section with new drilling segments in the form of annular sections for the drill bit from FIG. 1B (FIG. 2B);

FIGS. 3A-C show a cutting section that is connected to a severed drilling shaft; and

FIGS. 4A, B show a drilling shaft in which the drilling segments have been severed (FIG. 4A) and the cutting section from FIG. 3A, which has been welded to the severed drilling shaft (FIG. 4B).

### DETAILED DESCRIPTION

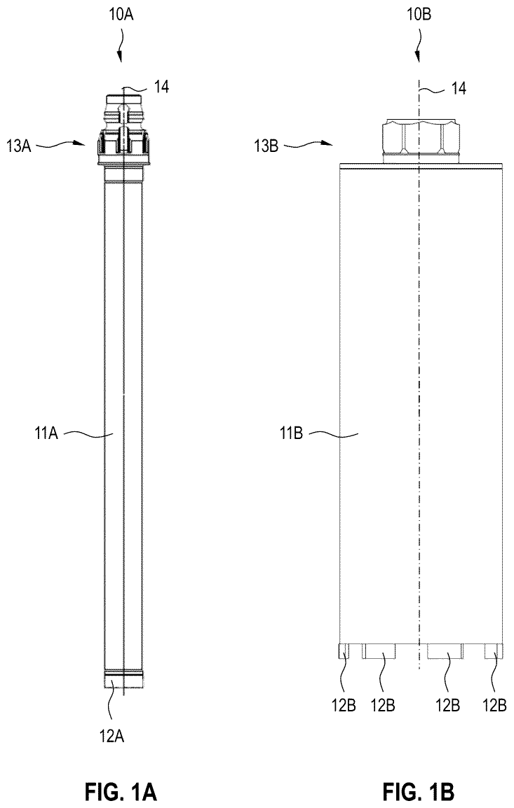

FIGS. 1A, B show a drill bit in a first variant (FIG. 1A) and a second variant (FIG. 1B). In this case, FIG. 1A shows a drill bit 10A with a drilling shaft 11A, an annular drilling segment 12A and a tool fitting 13A, and FIG. 1B shows a drill bit 10B with a drilling shaft 11B, a plurality of drilling segments in the form of annular sections 12B and a tool fitting 13B. The annular drilling segment 12A and the drilling segments in the form of annular sections 12B are firmly connected to the respective drilling shaft 12A, 12B, for example by adhesive bonding, soldering or welding. The drill bit 10A, 10B can be connected to a drilling device via the respective tool fitting 13A, 13B and be moved about a longitudinal axis 14.

In order for it to be possible to remove the annular drilling segment 12A of the drill bit 10A or the drilling segments in the form of annular sections 12B of the drill bit 10B and replace it/them with new drilling segments, the drilling shaft 11A, 11B is severed by means of a saw or cut-off grinder. The new drilling segments are fastened to a cutting section that is intended to be connected to the severed drilling shaft 11A, 11B.

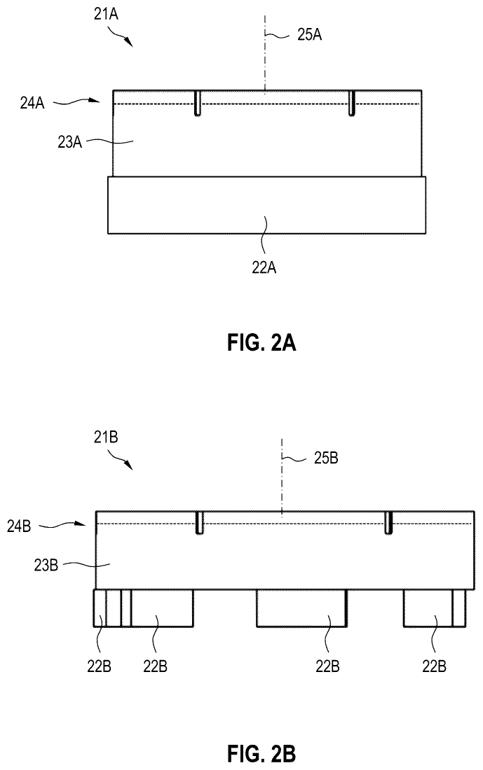

FIGS. 2A, B show a cutting section 21A with a new annular drilling segment for the drill bit 10A from FIG. 1A (FIG. 2A) and a cutting section 21B with a plurality of new drilling segments in the form of annular sections for the drill bit 10B from FIG. 1B (FIG. 2B).

The cutting section 21A for the drill bit 10A from FIG. 1A comprises a new annular drilling segment 22A, an annular section 23A and a plugging section 24A, and the cutting section 21B for the drill bit 10B from FIG. 1B comprises a plurality of drilling segments in the form of annular sections 22B, an annular section 23B and a plugging section 24B. The cutting section 21A has a longitudinal axis 25A and the cutting section 21B has a longitudinal axis 25B.

The cutting sections 21A, 21B differ in terms of the number of the new drilling segments, and the annular sections 23A, 23B and plugging sections 24A, 24B are of analogous construction and differ in particular by way of their diameter. The drill bit 10A is typically used for diameters of up to about 50 mm and the drill bit 10B is typically used for diameters starting from about 50 mm. The diameter of the drill bit and the number of drilling segments are unimportant for the method according to the invention for replacing the drilling segments of a drill bit.

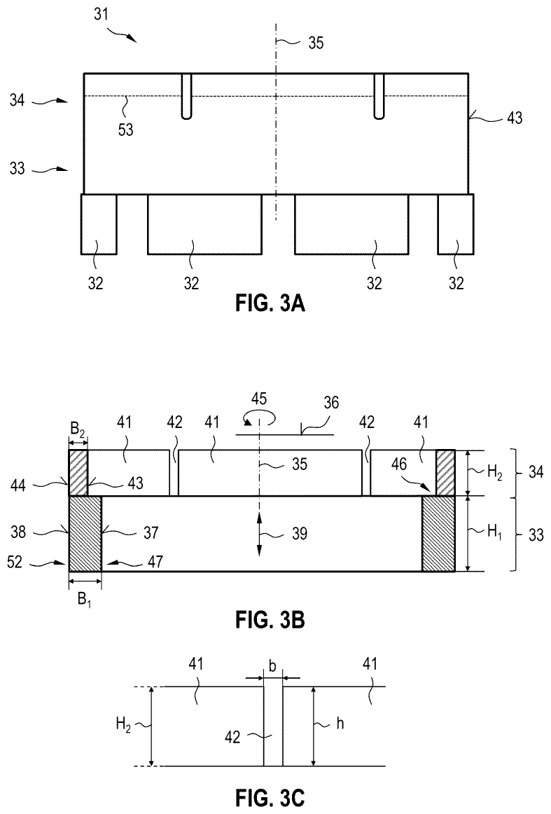

FIGS. 3A-C show a cutting section 31 which is intended to be connected to a severed drilling shaft. In this case, FIG. 3A shows the cutting section 31 in a side view, FIG. 3B shows a longitudinal section through the cutting section 31, and FIG. 3C shows an enlarged detail.

The cutting section 31 comprises a plurality of new drilling segments in the form of annular sections 32, an annular section 33 and a plugging section 34. The annular section 33 is of analogous construction to the annular section 23A of the cutting section 21A in FIG. 2A and to the annular section 23B of the cutting section 21B in FIG. 2B and the plugging section 34 is of analogous construction to the plugging section 24A of the cutting section 21A in FIG. 2A and to the plugging section 24B of the cutting section 21B in FIG. 2B. The cutting section 31 has a longitudinal axis 35.

The annular section 33 has, in a plane 36 perpendicular to the longitudinal axis 35, a first ring width B₁ between a first inner lateral surface 37 and a first outer lateral surface 38 and extends over a first ring height H₁ in a longitudinal direction 39, which extends parallel to the longitudinal axis 35.

Provided at that end of the annular section 33 that is remote from the new drilling segments is the plugging section 34, which is firmly connected to the annular section 33. The plugging section 34 is made up of a plurality of plugging elements 41 which are separated from one another by a plurality of longitudinal slots 42. The plugging elements 41 have, in the plane 36 perpendicular to the longitudinal axis 35, a second ring width B₂ between a second inner lateral surface 43 and a second outer lateral surface 44 and the plugging elements 41 extend over a second ring height H₂ in the longitudinal direction 39. In the exemplary embodiment, the plugging section 34 has six plugging elements 41, which are separated from one another via six longitudinal slots 42. The longitudinal slots 42 are distributed uniformly over the plugging section 34 in a circumferential direction 45 of the plugging section 34.

The second ring width B₂ of the plugging elements 41 is less than the first ring width B, of the annular section 33. Formed at the transition from the first inner lateral surface 37 to the second inner lateral surface 43 is an annular shoulder 46, which separates the annular section 33 and the plugging section 34 on an inner side 47 of the cutting section 31. In the exemplary embodiment, the first outer lateral surface 38 and the second outer lateral surface 44 are arranged in a flush manner; alternatively, a further annular shoulder can be formed at the transition from the first outer lateral surface 38 to the second outer lateral surface 44. The diameter of the second outer lateral surface 44 must not be greater than the outside diameter of the new drilling segments 32.

The longitudinal slots 42 have, in the plane 36 perpendicular to the longitudinal axis 35, a slot width b and extend over a slot height h in the longitudinal direction 39 (see, e.g., FIG. 3C). The longitudinal slots 42 extend substantially parallel to the longitudinal axis 35. The operator can feed in a filler metal via the externally accessible longitudinal slots 42 during welding.

The slot height h of the longitudinal slots 42 corresponds, in the exemplary embodiment, to the second ring height H₂ of the plugging section 34. If, as in the exemplary embodiment, the longitudinal slots 42 extend over the entire second ring height H₂ of the plugging section 34, the severed drilling shaft can be monitored while it is being welded to the cutting section 31. Monitoring is important especially when the drilling shaft has been severed obliquely and the severed drilling shaft does not bear against the annular shoulder 46 of the cutting section 31 around its entire circumference.

The plugging section 34 has, on an outer side 52, a marking element 53 (see, e.g., FIG. 3A) which is in the form of a marking line in the region of the longitudinal slots 42 and allows the connection between the cutting section 31 and a severed drilling shaft to be monitored. If the end face of the severed drilling shaft extends beneath the marking line 53, the minimum overlapping height has been satisfied and the longitudinal weld seams can create the required connection. If the end face of the severed drilling shaft does not have the requisite overlapping height at one or more longitudinal slots 42, the operator can rework the severed drilling shaft at the end face by means of the saw or the cut-off grinder until the end face of the severed drilling shaft has the minimum overlapping height at all the longitudinal slots 42.

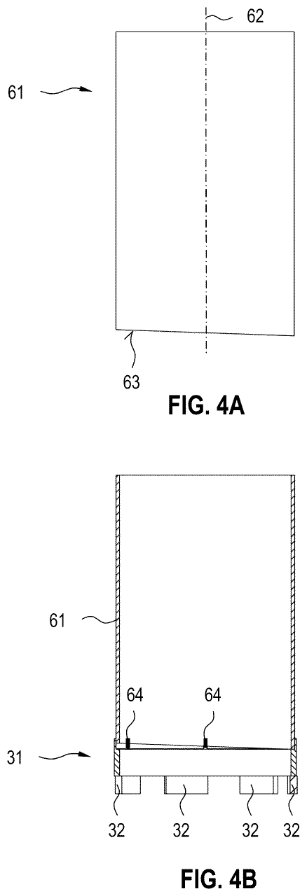

FIGS. 4A, B show a severed drilling shaft 61 from which the drilling segments have been severed (FIG. 4A) and the cutting section 31 from FIG. 2A, which has been plugged onto the severed drilling shaft 61 and welded to the severed drilling shaft 61 (FIG. 4B).

When the drilling shaft 61 is severed by means of a saw or cut-off grinder at the construction site, the separating cut frequently does not take place at right angles to a longitudinal axis 62 of the drilling shaft 61 and an obliquely extending end face 63 is formed on the severed drilling shaft 61. The obliquely extending end face 63 has the result that the end face 63 bears against the annular shoulder 46 of the cutting section 31 only in a small region.

In order to weld the cutting section 31 to the severed drilling shaft 61, the cutting section 31 is plugged onto the drilling shaft 61 until the end face 63 of the severed drilling shaft 61 butts against the annular shoulder 46 of the cutting section 31. In this position, the cutting section 31 and the severed drilling shaft 61 are connected together via a plurality of longitudinal weld seams 64. The longitudinal weld seams 64 extend over the entire slot height h of the longitudinal slots 42.

What is claimed is:

1-4. (canceled)

5: A method for replacing an annular drilling segment or a plurality of drilling segments in the form of annular sections of a drill bit, a drilling shaft being connected to the annular drilling segment or the drilling segments in the form of annular sections, with a new annular drilling segment or new drilling segments in the form of annular sections, the method comprising the steps of:
severing the drilling shaft;
plugging a cutting section having the new annular drilling segment or the new drilling segments in the form of annular sections onto the severed drilling shaft; and
connecting the cutting section to the severed drilling shaft via at least three longitudinal weld seams spaced apart from one another.

6: A cutting section for a drill bit, the cutting section having a longitudinal axis and comprising:
an annular section;
a new annular drilling segment connected to the annular section, or a plurality of new drilling segments in the form of annular sections connected to the annular section; and
a plugging section connected to the annular section, an annular shoulder being arranged at a transition of the plugging section to the annular section, the annular shoulder being arranged on an inner side of the cutting section and the plugging section having at least three plugging elements and at least three longitudinal slots separating the plugging elements from one another.

7: The cutting section as recited in claim 6 wherein the at least three longitudinal slots have, in a longitudinal direction extending parallel to the longitudinal axis of the cutting section, a slot height identical to a ring height of the plugging section.

8: The cutting section as recited in claim 6 wherein the plugging section has, in the region of the at least three longitudinal slots, a marking element extending in a plane perpendicular to the longitudinal axis of the cutting section.
